(19) United States
(12) Patent Application Publication
(10) Pub. No.: US 2014/0133355 A1
(43) Pub. Date: May 15, 2014

(54) METHOD FOR DETERMINING NEIGHBOR STATION, STATION, ACCESS POINT, AND COMMUNICATION SYSTEM

(71) Applicant: Huawei Device Co., Ltd., Shenzhen (CN)

(72) Inventor: Guiming SHU, Shenzhen (CN)

(73) Assignee: Huawei Device Co., Ltd., Shenzhen (CN)

(21) Appl. No.: 14/136,858

(22) Filed: Dec. 20, 2013

Related U.S. Application Data
(63) Continuation of application No. PCT/CN2013/071482, filed on Feb. 7, 2013.

(30) Foreign Application Priority Data
Feb. 13, 2012 (CN) 201210031634.4

(51) Int. Cl. H04W 48/16; H04W 52/02

(52) U.S. Cl. CPC H04W 48/16; H04W 52/0248
USPC 370/254

(57) ABSTRACT

A method for determining a neighbor station in a wireless local area network, and a station, an access point, and a communication system that adopt the method are provided. The method includes: sending, by a first station, a neighbor discovery request message to an access point; receiving, by the first station, a neighbor discovery response message from the access point, where the neighbor discovery response message includes information of one or more channel use time periods used for neighbor discovery; broadcasting, by the first station, a neighbor discovery message at preset communication power in channel use time periods; receiving, by the first station, a neighbor response message of a second station, where the neighbor response message includes station information of the second station; and determining, by the first station, a neighbor station based on the station information of the second station.

### CROSS-REFERENCE TO RELATED APPLICATION

This application is a continuation of International Patent Application No. PCT/CN2013/071482, filed on Feb. 7, 2013, which claims priority to Chinese Patent Application No. 201210031634.4, filed on Feb. 13, 2012, both of which are hereby incorporated by reference in their entireties.

### TECHNICAL FIELD

Embodiments of the present invention relate to the field of wireless communications, and in particular, to a method for determining a neighbor station in a wireless local area network, and a station, an access point, and a communication system that adopt the method.

### BACKGROUND

Currently, the IEEE standard organization is formulating the 802.11ah specification, and proposes a requirement that a coverage area of an access point (AP: Access Point) needs to reach one kilometer, which is 10 times a coverage distance of 100 meters of the access point supported in the existing 802.11 specification. In addition, a primary application scenario proposed for the 802.11ah is a sensor network, such as a network for forest fire detection. Because a coverage radius of an 11ah access point is 1 kilometer, which is much greater than a coverage range of 100 meters previously defined in specifications such as 802.11a/b/g/n. In order to implement effective detection in an area with a radius of 1 kilometer, the number of 802.11ah sensors to be deployed may possibly exceed 6000, and an STA (station: station) for sensing detection is generally powered by batteries. Besides, due to the number of deployed STAs and a deployment scenario (such as mountainous forests), it is inconvenient for a user to replace and maintain the battery of a sensor STA.

According to the existing 802.11 specification, both in uplink and downlink transmission, the STA working in a basic network mode directly communicates with an AP at the power negotiated with the AP, and the negotiated communication power is directly related to the distance between the STA and the AP, and therefore, STAs deployed in different distances from the AP in the coverage area of the AP consume power at different speeds in a process of communicating with the AP. Generally, under the condition of transmitting the same amount of data, the STA farther away from the AP consumes more power. In addition, due to the self-deployment of a sensor STA (for example, there is a barrier between the STA and the AP), power consumption may be increased.

Due to the foregoing reasons, when the remaining power of a sensor STA is reduced to a certain power value, the STA may fail to directly report monitoring data to the AP continuously for a long time (for example, the STA is far away from the AP). However, the STA with low power can still report monitoring data at low transmit power in a manner in which a neighbor STA in an adjacent area relays data to the AP, so as to avoid that detection data is neglected in the environment when an accident happens, until a maintenance person replaces the battery. This requires that the STA in the coverage area of the AP firstly can automatically discover, in an adjacent area, a neighbor STA that can relay data to the AP for the STA.

In the deployment of the wireless local area network, information of a peripheral neighbor STA of each STA is configured in the AP or the STA according to the deployment location of each STA, and a list of neighbor STAs is maintained in the AP or each STA. However, in the solution of obtaining the neighbor STA through configuration, human participation is needed in a process of configuring STA neighbor information, which is inconvenient for operation, for example, information of the deployment location of each STA needs to be recorded, or the STA needs to obtain information of the deployment location on its own through a positioning function. When the STA needs to support the positioning function to obtain the information of the deployment location, the deployment costs of the wireless local area network are increased significantly. In addition, because the STA neighbor information is fixedly configured in the foregoing solution, difficulties of STA deployment and maintenance are increased correspondingly. For example, when a deployment position of an STA changes, neighbor information needs to be re-configured in the AP or the STA.

Therefore, in the prior art, the neighbor station needs to be effectively determined in the wireless local area network.

### SUMMARY

Based on the foregoing objective, the present invention is invented, and an objective of the present invention is to provide a method for determining a neighbor station in a wireless local area network, and a station, an access point, and a communication system that adopt the method, so that an STA can automatically discover a peripheral neighbor STA in real time.

In one aspect, a method for determining a neighbor station in a wireless local area network is provided, and the method includes: sending, by a first station, a neighbor discovery request message to an access point; receiving, by the first station, a neighbor discovery response message from the access point, where the neighbor discovery response message includes information of one or more channel use time periods used for neighbor discovery, where the information is allocated by the access point to the first station; broadcasting, by the first station, a neighbor discovery message at preset communication power in the one or more channel use time periods used for neighbor discovery; receiving, by the first station, a neighbor response message responded to the neighbor discovery message by the second station, where the neighbor response message includes station information of the second station; and determining, by the first station, a neighbor station based on the station information of the second station.

In another aspect, a method for determining a neighbor station in a wireless local area network is provided, and the method includes: receiving, by an access point, a neighbor discovery request message sent by a first station; allocating, by the access point, one or more channel use time periods used for neighbor discovery to the first station; and sending, by the access point, a neighbor discovery response message to the first station, where the neighbor discovery response message includes information of the one or more channel use time periods.

In another aspect, a station deployed in a wireless local area network is provided, and the station includes: a first sending unit, configured to send a neighbor discovery request message to an access point; a first receiving unit, configured to receive a neighbor discovery response message from the access point, where the neighbor discovery response message includes information of one or more channel use time periods used for neighbor discovery, where the information is allocated by the access point to the station; a broadcasting unit, configured to broadcast a neighbor discovery message at preset communication power in the one or more channel use time periods used for neighbor discovery; a first receiving unit, configured to receive a neighbor response message responded to the neighbor discovery message by another station, where the neighbor response message includes station information of another station; and a determining unit, configured to determine a neighbor station based on the station information of the another station.

In another aspect, an access point deployed in a wireless local area network is provided, and the access point includes: a first receiving unit, configured to receive a neighbor discovery request message sent by a station performing neighbor discovery; an allocating unit, configured to allocate one or more channel use time periods used for neighbor discovery to a first station; and a first sending unit, configured to send a neighbor discovery response message to the first station, where the neighbor discovery response message includes information of the one or more channel use time periods.

In another aspect, a method for determining a neighbor station in a wireless local area network is provided, and the method includes: receiving, by a first station, a message frame on which a second station communicates with an access point, where the message frame includes information of power used by the second station to send the message frame when communicating with the access point; determining signal strength of the received message frame; and determining a neighbor station based on the power information and the signal strength.

In another aspect, a station deployed in a wireless local area network is provided, and the station includes: a first receiving unit, configured to receive a message frame on which another station communicates with an access point, where the message frame includes information of power used by the another station to send the message frame when communicating with the access point; a first determining unit, configured to determine signal strength of the received message frame; and a second determining unit, configured to determine a neighbor station based on the power information and the signal strength.

By using the method for determining a neighbor station in a wireless local area network, and the station, the access point, and the communication system that adopt the method according to the embodiments of the present invention, a method in which an STA automatically sends a neighbor discovery message to another STA, or receives a message frame sent by another STA is used, so that each STA may automatically discover a neighbor STA thereof in real time without configuring neighbor station information in advance when deploying a network, which is convenient for a user to deploy and maintain a sensor network that is based on a wireless local area network.

### BRIEF DESCRIPTION OF DRAWINGS

To illustrate the technical solutions in the embodiments of the present invention more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic flowchart of a method for determining a neighbor station in a wireless local area network according to a first embodiment of the present invention;

FIG. 2 is another schematic flowchart of the method for determining a neighbor station in a wireless local area network according to the first embodiment of the present invention;

FIG. 3 is a schematic diagram showing an application of the method for determining a neighbor station according to the first embodiment of the present invention in a wireless local area network;

FIG. 4 is a schematic flowchart showing a method for determining a neighbor station in a wireless local area network according to a second embodiment of the present invention; and

FIG. 5 is a schematic diagram showing an application of the method for determining a neighbor station according to the first embodiment of the present invention in a wireless local area network;

FIG. 6 is a schematic diagram showing an station provided by the first embodiment of the present invention;

FIG. 7 is a schematic diagram showing an access point provided by the first embodiment of the present invention;

FIG. 8 is a schematic diagram showing an station provided by the second embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely a part rather than all of the embodiments of the present invention. All other embodiments obtained by a person of ordinary skill in the art based on the embodiments of the present invention without creative efforts shall fall within the protection scope of the present invention.

For an application scenario of an 802.11ah wireless local area network, such as a sensor network, an STA needs to have the capability to automatically discover a peripheral neighbor STA, so that when the power of the STA is low, the STA can request the peripheral neighbor STA to relay data to be transmitted to an AP, so as to reduce power consumption of an STA far away from the AP; therefore, STAs in different areas of the coverage area of the access point nearly have balanced power consumption, thereby improving communication performance of the entire wireless local area network, and making it convenient for a user to deploy and maintain the sensor network that is based on the wireless local area network.

A first embodiment of the present invention provides a method for determining a neighbor station in a wireless local area network, and the method includes: sending, by a first station, a neighbor discovery request message to an access point; receiving, by the first station, a neighbor discovery response message from the access point, where the neighbor discovery response message includes information of one or more channel use time periods used for neighbor discovery, where the information is allocated by the access point to the first station; broadcasting, by the first station, a neighbor discovery message at preset communication power in the one or more channel use time periods used for neighbor discovery; receiving, by the first station, a neighbor response message responded to the neighbor discovery message by a second station, where the neighbor response message includes station information of the second station; and determining, by the first station, a neighbor station based on the station information of the second station.

By using the method for determining a neighbor station in a wireless local area network, each STA may broadcast a neighbor discovery message at expected power or power corresponding to an expected distance to automatically discover a peripheral neighbor STA, so as to relay data to be transmitted, thereby reducing power consumption thereof, improving communication performance of the entire wireless local area network, and promoting deployment and maintenance of the wireless local area network.

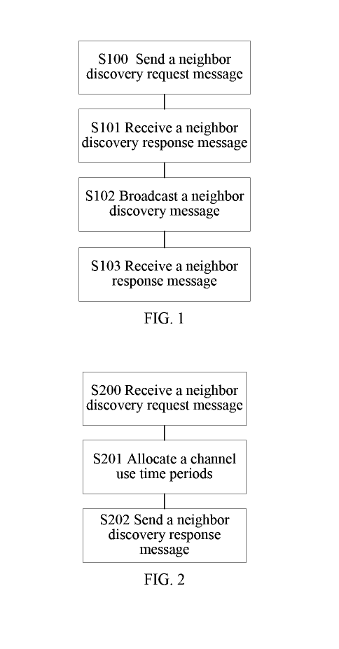

FIG. 1 is a schematic flowchart of a method for determining a neighbor station in a wireless local area network according to a first embodiment of the present invention. As shown in FIG. 1, the method includes: S100, a first STA performing neighbor discovery sends a neighbor discovery request message to an AP; S101, the first STA performing neighbor discovery receives a neighbor discovery response message from the AP, where the neighbor discovery response message includes information of one or more channel use time periods used for neighbor discovery, where the information is allocated by the AP to the first STA performing neighbor discovery; S102, the first STA performing neighbor discovery broadcasts a neighbor discovery message at preset communication power in the allocated one or more channel use time periods used for neighbor discovery; and S103, the first STA performing neighbor discovery receives a neighbor response message responded to the neighbor discovery message by a second STA, where the neighbor response message includes station information of the second STA, so that the first STA performing neighbor discovery determines a neighbor STA based on the station information of the second STA.

Because the power at which the STA transmits data is in directly proportional to a distance of data transmission, the longer the distance of data transmission is, the more the power consumed by the STA for data transmission is. Therefore, a person of ordinary skill in the art may understand that, in the method for determining a neighbor station in a wireless local area network, the STA may select, according to a specific power consumption requirement, preset power at which a neighbor discovery message is broadcasted, that is, the STA broadcasts a neighbor discovery message at expected power. For example, when an STA can bear more power consumption, it may broadcast a neighbor discovery message at larger expected power. In this case, the discovered neighbor STA is farther away from the STA geographically, and because a range covered by the neighbor discovery message is broader, there is a bigger possibility to discover a neighbor STA. Oppositely, when an STA can only bear small power consumption, it may broadcast a neighbor discovery message at smaller expected power, thereby limiting that the discovered neighbor STA is closer to the STA geographically. However, because a range covered by the neighbor discovery message is smaller, and a neighbor STA may not be discovered effectively, in the method for determining a neighbor station in a wireless local area network according to the embodiment of the present invention, power at which the neighbor discovery message is broadcasted may be increased in the case in which the neighbor STA is not discovered effectively, thereby expanding the range covered by the neighbor discovery message, so as to effectively discover a neighbor STA.

In the foregoing method for determining a neighbor station in a wireless local area network, before the sending, by an STA performing neighbor discovery, a neighbor discovery request message to an AP, the method further includes: sending, by the STA performing neighbor discovery, an association request message to the AP, where the association request message includes information indicating that the STA performing neighbor discovery supports an automatic neighbor discovery capability.

Specifically, when an STA is initially deployed in an area covered by the AP, the STA firstly needs to perform an initial network entry process. Therefore, before sending the neighbor discovery request message to the AP, the STA firstly needs to communicate with the AP, so as to perform the initial network entry process, such as authentication and association, and the STA may indicate, to the AP through a message (such as an association request message) in the initial network entry process, that the STA supports the automatic neighbor discovery capability. In this case, the AP may obtain a list of STAs in the coverage area that are capable of performing automatic neighbor discovery, which is further convenient for managing the STAs in the coverage range.

In addition, in the foregoing method for determining a neighbor station in a wireless local area network, in the neighbor discovery request message sent by the STA to the AP, information of an objective and/or a cause of neighbor discovery may be carried in the message according to a requirement, and in a neighbor discovery message sent by an STA that needs to perform neighbor discovery to another STA, the information of the objective and/or the cause of neighbor discovery may also be carried.

As described in the above, because in the wireless local area network according to the embodiment of the present invention, each STA wakes up in a fixed time period to communicate with the AP, and only the AP knows the wake-up time period of each STA. Therefore, the STA that needs to perform neighbor discovery needs to obtain a time period allocated by the AP for broadcasting a neighbor discovery request, which is herein called as a channel use time period (SP, service period). The AP here may arrange, according to a wake-up time of each STA in the coverage area, a channel use time period used for neighbor discovery for the STA that needs to perform neighbor discovery. For example, the allocated channel use time period for a user to perform neighbor discovery may correspond to wake-up time periods of all other STAs in the coverage range of the AP, so that each of other STAs can receive a neighbor sending message broadcast by the STA that needs to perform neighbor discovery. Or, the AP may allocate channel use time periods except the wake-up time period when each STA communicates with the AP, thereby ensuring efficiency of neighbor discovery. In this case, the AP needs to notify the STA in the coverage range of the one or more channel use time periods, so that a part or all of the STAs in the coverage range wake up in the one or more channel use time periods to receive the neighbor discovery message broadcast by the STA that needs to perform neighbor discovery. That is, in addition to the wake-up time period when each STA communicates with the AP, the STAs wake up in the channel use time periods, and the foregoing wake-up time period refers to a time period when each STA wakes up when communicating with the AP.

As described in the above, when the AP allocates one or more channel use time periods used for neighbor discovery to the STA, it may need to notify other STAs in the coverage range of the one or more channel use time periods at the same time, so that the STAs can wake up in the one or more channel use time periods to receive the neighbor discovery message broadcast by the STA that needs to perform neighbor discovery, so as to make a response. The AP here may simply notify all STAs in the coverage range of the one or more channel use time periods, or may select a part of STAs according to stored STA information. Because in the wireless local area network, each STA communicates with the AP at specified power according to the distance between the STA and the AP, the AP may know information of power at which each STA in the coverage range communicates with the AP. When the AP receives the neighbor discovery request message from the STA, the AP may select another STA having similar power to that of the STA according to the power information of the STA that needs to perform neighbor discovery, which is because if some STAs have similar power information, it is possible that they are in a close geographic area. In addition, a directional communication technology supported by a current smart antenna may be applied to help determine an STA in an adjacent area, that is, in the case in which the directional communication technology supported by the smart antenna is adopted when the STA communicates with the AP, the AP may roughly know a location of the STA in the coverage range. Therefore, the AP may select a part of STAs by using the power information of the STA and with reference to the location information, and notify them of the one or more channel use time periods, so that the STAs wake up in the one or more channel use time periods, so as to implement neighbor discovery of the STA that needs to perform neighbor discovery. In this case, the AP does not need to notify all STAs in the coverage range of the one or more channel use time periods, but may selectively notify a part of STAs of the one or more channel use time periods, thereby reducing system loads, and improving efficiency of neighbor discovery of the STA.

Moreover, it is mentioned in the above that the neighbor discovery request message sent by the STA to the AP may carry the information of the objective and/or the cause of neighbor discovery, the AP may also select a part of STAs according to the information of the objective and/or the cause. For example, if the objective for the STA to request neighbor discovery is to relay data to be transmitted, power condition of each STA should be considered, and if an STA selected as a neighbor STA by an STA that needs to relay data to be transmitted has lower power than the STA, it is apparent that balanced power consumption of the STAs cannot be achieved effectively through relaying of data transmission. Therefore, during selection, the AP should consider the power condition of each STA, thereby selecting a part of STAs and notifying them of the one or more channel use time periods, so that the STAs wake up in the one or more channel use time periods. In this case, the AP firstly may limit the range of other STAs to which the STA that needs to perform neighbor discovery broadcasts the neighbor discovery message, thereby improving running efficiency of the entire system.

In addition, as described above, in another situation, the one or more channel use time periods allocated by the AP to the STA that needs to perform neighbor discovery may be the wake-up cycles of all other STAs, and same as the above description, the one or more channel use time periods allocated by the AP to the STA that needs to perform neighbor discovery may also be wake-up time periods of a part of STAs selected by the AP based on the foregoing conditions. In this case, because a time length of the wake-up time period of the STA that needs to perform neighbor discovery is reduced, power consumption of the STA may be reduced.

In the foregoing method for determining a neighbor station in a wireless local area network, when the STAs around the STA that needs to perform neighbor discovery receive the broadcast neighbor discovery message, because as described above, each expected power corresponds to a neighbor distance, the STA capable of receiving the neighbor discovery message is considered in a neighbor range of the STA that needs to perform neighbor discovery. In this case, the STA receiving the neighbor discovery message returns a neighbor response message to the STA that needs to perform neighbor discovery, and the neighbor response message includes information of the neighbor STA, such as STA identifier information of the neighbor STA, or IP address information of the neighbor STA. Here, when multiple neighbor STAs exist in a range covered by a neighbor request message, each neighbor STA sends a neighbor response message to the STA that needs to perform neighbor discovery, therefore the neighbor response messages may interfere with each other. In order to avoid mutual interference between the neighbor response messages, while notifying the STA in the coverage range of the one or more channel use time periods, the AP may indicate, to each STA, different times or different sub-channel frequency bands (also called as channel sub-frequency band or sub-carrier) for returning the neighbor response message. Here, a person skilled in the art may understand that, a channel frequency band in which the STA communicates with the AP may be divided into multiple different channel sub-frequency bands, and therefore, in order to avoid mutual interference between neighbor response messages, different channel sub-frequency bands for returning the neighbor response message may be indicated to each STA. That is, the STA that needs to perform neighbor discovery may receive the neighbor response messages from different STAs that are sent in a time division multiplexing manner or a frequency division multiplexing manner, thereby avoiding mutual interference between neighbor response messages from different STAs, and further improving efficiency of neighbor discovery.

In addition, in the foregoing method for determining a neighbor station in a wireless local area network, when the STA discovers a neighbor STA according to neighbor STA information in the received neighbor response message, a neighbor list of discovered neighbor STAs may be generated, and the neighbor list may be reported to the AP. After receiving the neighbor list sent by the STA, the AP may further confirm the neighbor STAs included in the neighbor list according to the stored STA information, such as communication power and authentication information of each STA. For example, when another STA in a different AP coverage range from the STA that needs to perform neighbor discovery accidentally receives the neighbor request message and makes a response, the STA that needs to perform neighbor discovery also adds the STA to its neighbor list. However, because the STA does not belong to the same AP coverage range as the STA that needs to perform neighbor discovery, the STA that needs to perform neighbor discovery actually cannot relay data to be transmitted through the STA, and therefore the STA is an invalid neighbor STA. And because the AP manages information of all STAs in the coverage range, the AP may exclude the invalid STA from the neighbor list of STAs, thereby improving validity of neighbor discovery. Or, as described above, for example, the AP deletes, according to the information of the objective and/or the cause of neighbor discovery of the STA, an STA with lower power than the STA performing neighbor discovery, thereby improving validity of neighbor discovery. Therefore, the AP may perform authentication according to conditions, such as whether the neighbor STA is authenticated successfully by the AP, and whether the neighbor STA accesses the network successfully, and if the objective of neighbor discovery is to relay data to be sent, the AP also needs to check whether the remaining power of the neighbor STA satisfies a relay requirement.

It should be noted that, the channel use time period in the foregoing example is a use time period corresponding to a channel frequency band used when a current STA communicates with the AP. In addition, a channel corresponding to the channel use time period may be different from a channel frequency band used when the current STA communicates with the AP. In this case, when sending the neighbor discovery response message to the STA performing neighbor discovery, in addition to carrying the information of the one or more channel use time periods used for neighbor discovery, the AP needs to further carry identifier information of a corresponding channel frequency band, such as a channel number or a channel center frequency. Correspondingly, when the AP needs to notify another STA in the coverage range of the one or more channel use time periods, the AP also needs to carry identifier information of a corresponding channel frequency band, such as a channel number or a channel center frequency, so that the STA performing neighbor discovery switches from the one or more channel use time periods to the corresponding channel to send a neighbor discovery message and receive a neighbor response message, and the another STA in the coverage range switches from the one or more channel use time periods to the corresponding channel correspondingly to receive the neighbor discovery message or send the neighbor response message.

A first embodiment of the present invention further provides a method for determining a neighbor station STA in a wireless local area network, and the method includes: receiving, by an AP, a neighbor discovery request message sent by a first STA performing neighbor discovery; allocating, by the AP, one or more channel use time periods used for neighbor discovery to the first STA performing neighbor discovery; and sending, by the AP, a neighbor discovery response message to the first STA performing neighbor discovery, where the neighbor discovery response message includes information of the one or more channel use time periods.

FIG. 2 is another schematic flowchart of the method for determining a neighbor station in a wireless local area network according to the first embodiment of the present invention. As shown in FIG. 2, S200, an AP receives a neighbor discovery request message sent by an STA performing neighbor discovery; S201, the AP allocates one or more channel use time periods used for neighbor discovery to the STA performing neighbor discovery; S202, the AP sends a neighbor discovery response message to the STA performing neighbor discovery, where the neighbor discovery response message includes information of the one or more channel use time periods, where the STA performing neighbor discovery broadcasts a neighbor discovery message at preset communication power in the allocated one or more channel use time periods; the STA receives a neighbor response message responded to the neighbor discovery message by another STA, where the neighbor response message includes information of a neighbor STA, so that the STA performing neighbor discovery determines a neighbor STA based on the information of the neighbor STA.

In the foregoing method, before the receiving, by an access point, a neighbor discovery request message from a first station, the method further includes: receiving, by the access point, an association request message from the first station, where the association request message includes information indicating that the first station supports an automatic neighbor determining capability.

In the foregoing method, the neighbor discovery request message received by the access point from the first station further includes information of a cause and/or an objective for the first station to perform neighbor discovery.

In the foregoing method, the one or more channel use time periods correspond to wake-up time periods of all other stations in the wireless local area network, or wake-up time periods of a part of other stations selected by the access point based on the information of the cause and/or the objective for the first station to perform neighbor discovery.

In the foregoing method, the one or more channel use time periods are time periods except wake-up time periods of one or more other stations in the wireless local area network; and the allocating, by the access point, one or more channel use time periods used for neighbor discovery to the first station further includes: sending, by the access point, a neighbor discovery indication message to all the other stations in the wireless local area network or to a part of other stations selected by the access point based on the information of the cause and/or the objective for the first station to perform neighbor discovery, where the neighbor discovery indication message includes information of the one or more channel use time periods.

In the foregoing method, the neighbor discovery response message further includes information of another channel frequency band for performing neighbor discovery, where the information is allocated by the access point to the first station, and the another channel frequency band is different from a channel frequency band for the first station to communicate with the access point.

In the foregoing method, the information of the another channel frequency band for performing neighbor discovery includes at least one of: a number of the another channel frequency band and a center frequency of the another channel frequency band.

In the foregoing method, after the determining, by the first station, a neighbor station based on neighbor station information, the method further includes: receiving, by the access point, a neighbor report request message from the first station, where the neighbor report request message includes the neighbor station information; determining, by the access point, the neighbor station as a valid neighbor station according to stored status information corresponding to the neighbor station; and sending, by the access point, a neighbor report response message to the station, where the neighbor report response message includes the information of the valid neighbor station.

In the method described above with reference to FIG. 2, the AP may allocate a channel use time period to each STA for automatically discovering a peripheral neighbor STA, so that each STA broadcasts a neighbor discovery message at expected power to automatically discover a peripheral neighbor STA to relay data to be transmitted, thereby reducing power consumption thereof, improving communication performance of the entire wireless local area network, and promoting deployment and maintenance of the wireless local area network.

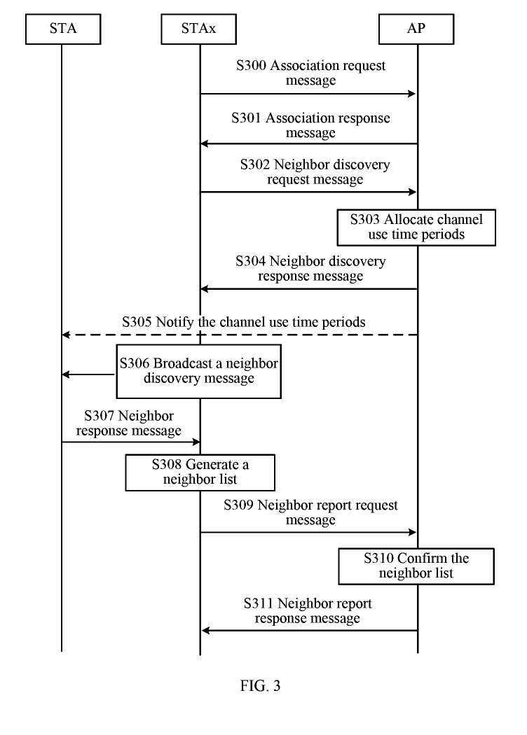

FIG. 3 is a schematic diagram showing an application of the method for determining a neighbor station according to the first embodiment of the present invention in a wireless local area network. As shown in FIG. 3, when needing to perform neighbor discovery, in S300, an STA that needs to perform neighbor discovery (marked as STAx in FIG. 3) sends an association request message to an AP, so as to indicate an automatic neighbor discovery capability to the AP. In S301, the STAx receives an association response message from the AP, thereby completing an initial network entry process. In S302, the STAx sends a neighbor discovery request message to the AP, and as described above, the neighbor discovery request message may include information of an objective and/or a cause of neighbor discovery. In S303, the AP allocates, according to wake-up time of the STA in the coverage range, one or more channel use time periods used for neighbor discovery to the STAx. In 304, the AP notifies the STAx of the allocated one or more channel use time periods through a neighbor discovery response message. And in S305, the AP notifies all or a part of STAs of the allocated one or more channel use time periods. In S306, the STAx broadcasts a neighbor discovery message in the allocated one or more channel use time periods at power corresponding to an expected neighbor distance. In S307, the STA receiving the neighbor discovery message returns a neighbor response message to the STAx, and as described above, if multiple STAs returns the neighbor response messages to the STAx, mutual interference may be reduced based on a time division or frequency division manner. In S308, the STAx receives the neighbor response messages, and generates a neighbor list based on the neighbor STA information. In S309, the STAx sends a neighbor report request message to the AP, where the neighbor report request message includes the neighbor list generated in the STAx. In S310, the AP confirms the neighbor list of the STAx based on the stored STA information, thereby, for example, excluding an STA not associated with the AP. In S311, the AP notifies the STAx of an available neighbor list through a neighbor report response message, and in this case, the STAx needing to perform neighbor discovery may automatically discover a neighbor STA for relaying data transmission.

The first embodiment of the present invention further provides a station deployed in a wireless local area network, and the station includes: a first sending unit, configured to send a neighbor discovery request message to an access point; a first receiving unit, configured to receive a neighbor discovery response message from the access point, where the neighbor discovery response message includes information of one or more channel use time periods used for neighbor discovery, where the information is allocated by the access point to the station; a broadcasting unit, configured to broadcast a neighbor discovery message at preset communication power in the one or more channel use time periods used for neighbor discovery; a first receiving unit, configured to receive a neighbor response message responded to the neighbor discovery message by another station, where the neighbor response message includes station information of another station; and a determining unit, configured to determine a neighbor station based on the station information of the another station.

The foregoing station further includes: a second sending unit, configured to send an association request message to the access point, where the association request message includes information indicating that the first station supports an automatic neighbor discovery capability.

In the foregoing station, the neighbor discovery request message sent to the access point further includes information of a cause and/or an objective for the station to perform neighbor discovery.

In the foregoing station, the one or more channel use time periods correspond to wake-up time periods of all other stations in the wireless local area network, or wake-up time periods of a part of other stations selected by the access point based on the information of the cause and/or the objective for the station to perform neighbor discovery.

In the foregoing station, the one or more channel use time periods are time periods except wake-up time periods of one or more other stations in the wireless local area network.

The access point sends a neighbor discovery indication message to all the other stations in the wireless local area network, or to a part of other stations selected by the access point based on the information of the cause/the objective for the station to perform neighbor discovery, where the neighbor discovery indication message includes information of the one or more channel use time periods, so that all the other stations in the wireless local area network or the part of other stations selected by the access point based on the information of the cause and/or the objective for the station to perform neighbor discovery wake up in the one or more channel use time periods to receive the neighbor discovery indication message sent by the access point.

In the foregoing station, the neighbor discovery response message further includes information of another channel frequency band for performing neighbor discovery, where the information is allocated by the access point to the station, where the another channel frequency band is different from a channel frequency band for the station to communicate with the access point; and the broadcasting unit is specifically configured to: broadcast a neighbor discovery message by using the another channel frequency band at preset communication power in the one or more channel use time periods used for neighbor discovery, where the neighbor discovery indication message includes information of the another channel frequency band, so that all the other stations in the wireless local area network or the part of other stations selected by the access point based on the information of the cause and/or the objective for the station to perform neighbor discovery receive, by using the another channel frequency band, the neighbor discovery indication message sent by the access point.

In the foregoing station, the information of the another channel frequency band for performing neighbor discovery includes at least one of: a number of the another channel frequency band and a center frequency of the another channel frequency band.

In the foregoing station, the first receiving unit is specifically configured to: receive a neighbor response message responded to the neighbor discovery message by the another station in a time division multiplexing manner or a frequency division multiplexing manner.

The foregoing station further includes: a third sending unit, configured to send a neighbor report request message to the access point, where the neighbor report request message includes the neighbor station information, so that the access point determines the neighbor station as a valid neighbor station according to stored status information of the neighbor station; and a second receiving unit, configured to receive a neighbor report response message from the access point, where the neighbor report response message includes the information of the valid neighbor station.

In addition, the embodiment of the present invention further provides an access point deployed in a wireless local area network, and the access point includes: a first receiving unit, configured to receive a neighbor discovery request message sent by a station performing neighbor discovery; an allocating unit, configured to allocate one or more channel use time periods used for neighbor discovery to a first station; and a first sending unit, configured to send a neighbor discovery response message to the first station, where the neighbor discovery response message includes information of the one or more channel use time periods.

The foregoing access point further includes: a second receiving unit, configured to receive an association request message from the first station, where the association request message includes information indicating that the first station supports an automatic neighbor determining capability.

In the foregoing access point, the neighbor discovery request message received from the first station further includes information of a cause and/or an objective for the first station to perform neighbor discovery.

In the foregoing access point, the one or more channel use time periods correspond to wake-up time periods of all other stations in the wireless local area network, or wake-up time periods of a part of other stations selected by the access point based on the information of the cause and/or the objective for the first station to perform neighbor discovery.

In the foregoing access point, the one or more channel use time periods are time periods except wake-up time periods of one or more other stations except the first station in the wireless local area network; and the allocating unit is further configured to: send a neighbor determining indication message to all the other stations in the wireless local area network, or to a part of other stations selected by the access point based on the information of the cause and/or the objective for the first station to perform neighbor discovery, where the neighbor determining indication message includes information of the one or more channel use time periods.

In the foregoing access point, the neighbor discovery response message further includes information of another channel frequency band for performing neighbor discovery, where the information is allocated by the access point to the first station, and the another channel frequency band is different from a channel frequency band for the first station to communicate with the access point.

In the foregoing access point, the information of the another channel frequency band for performing neighbor discovery includes at least one of: a number of the another channel frequency band and a center frequency of the another channel frequency band.

The foregoing access point further includes: a third receiving unit, configured to receive a neighbor report request message from the first station, where the neighbor report request message includes neighbor station information; a determining unit, configured to determine the neighbor station as the valid station according to stored status information corresponding to the neighbor station; and a second sending unit, configured to send a neighbor report response message to the station, where the neighbor report response message includes the information of the valid neighbor station.

The first embodiment of the present invention further provides a communication system including the station and the access point.

A second embodiment of the present invention further provides a method for determining a neighbor station STA in a wireless local area network, and the method includes: receiving, by a first station, a message frame on which a second station communicates with an access point, where the message frame includes information of power used by the second station to send the message frame when communicating with the access point; determining signal strength of the received message frame; and determining a neighbor station based on the power information and the signal strength.

In the method for determining a neighbor station in a wireless local area network, an STA performing neighbor discovery determines the distance between another STA and the AP through power information indicated in the received message frame on which the another STA communicates with the AP and with reference to detected signal strength of the message frame, thereby discovering the neighbor STA. In this case, the STA may automatically discover the neighbor STA to relay data to be transmitted, thereby reducing power consumption thereof, improving communication performance of the entire wireless local area network, and promoting deployment and maintenance of the wireless local area network by avoiding human participation.

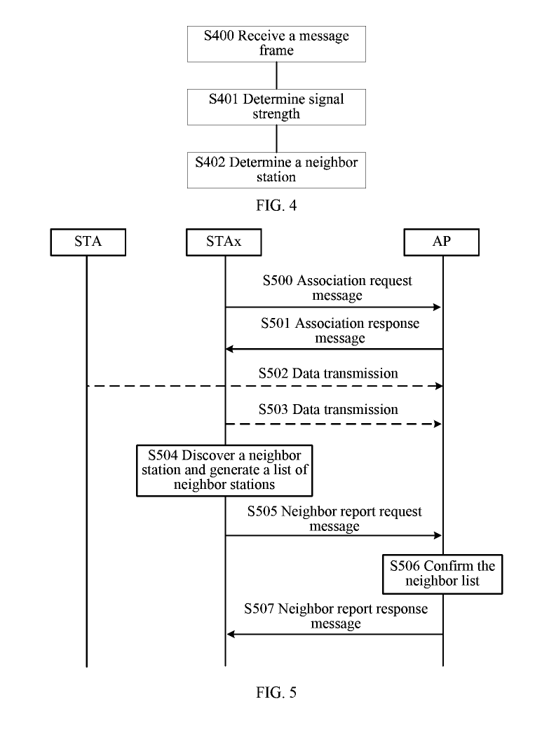

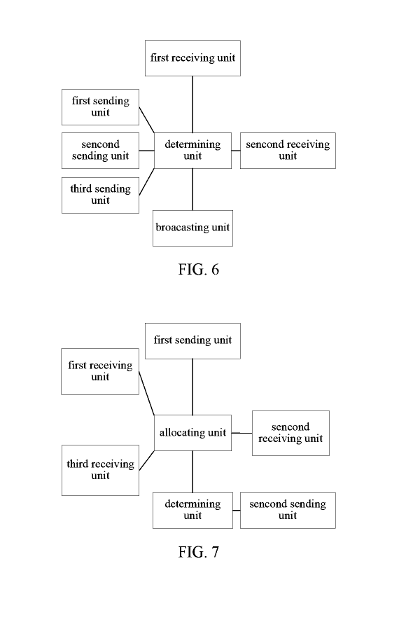

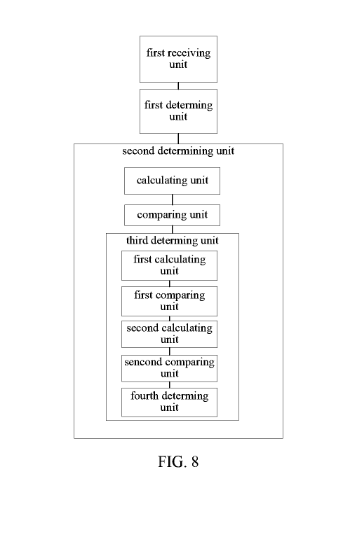

FIG. 4 is a schematic flowchart showing a method for neighbor discovery in a wireless local area network according to a second embodiment of the present invention. As shown in FIG. 4, the method includes: S400, an STA performing neighbor discovery receives a message frame on which another STA communicates with an AP, where the message frame includes information of power used by the another STA to send the message frame when communicating with the AP; S401, determine signal strength of the received message frame; and S402, determine a neighbor STA based on the power information and the signal strength.

In the foregoing method for determining a neighbor station in a wireless local area network, same as the first embodiment of the present invention, each STA wakes up in a fixed time period to communicate with the AP, thereby, for example, in an application of a sensor network, reporting sensor data to the AP according a set sensor data reporting cycle. Therefore, an STA that needs to perform neighbor discovery needs to wake up in a time period except the wake-up time period thereof, so as to receive a message frame on which another STA communicates with the AP. Here, a person skilled in the art may understand that, the message frame on which the another STA communicates with the AP may be a message frame sent from another STA to the AP, or may be a message frame sent from the AP to another STA. Here, in order to enhance comprehensiveness of neighbor discovery, the STA that needs to perform neighbor discovery may remain a wake-up status in the time periods in which all STAs communicate with the AP, so as to receive all message frames on which the STA communicates with the AP. In addition, the STA that needs to perform neighbor discovery may also be set to end the wake-up status after discovering the specified number of neighbor STAs, so as to reduce possible consumption. A time length of the wake-up time period of the STA that needs to perform neighbor discovery may be specifically configured according to actual conditions, on which the embodiment of the present invention does not intend to impose any limitation.

After receiving the message frame on which the another STA communicates with the AP, the STA that needs to perform neighbor discovery detects signal strength of the received message frame, and compares the signal strength with information of power included in the message frame and used for the STA to initially send the message frame, thereby determining the distance between the STA corresponding to the received message frame and the STA that needs to perform neighbor discovery. Here, because an attenuation amplitude of the signal strength is in directly proportional to a signal transmission distance, the STA that needs to perform neighbor discovery may set, for example, that an STA with a difference value between the detected signal strength and initial transmit power smaller than a specified threshold is a neighbor STA, where the specified threshold may be an appropriate value set according to the network environment, on which the embodiment of the present invention does not intend to impose any limitation.

In addition, in the foregoing method for determining a neighbor station in a wireless local area network according to the second embodiment of the present invention, the STA that needs to perform neighbor discovery may further help determine the neighbor STA with reference to information of power at which the STA communicates with the AP. As described above, the STA having same communication power as the AP is located in a circle with the AP as the center and a specified radius, and if location information in directional transmission is combined, the STA having similar communication power to that of the AP may possibly be located in a geographically closer location. In some special cases, for example, when a barrier exists between the STA that needs to perform neighbor discovery and a discovered neighbor STA, but the STA receives a reflected message frame of the neighbor STA, the STA may still be considered as the neighbor STA. However, actually the STA cannot be taken as the neighbor STA due to the existence of the barrier. Therefore, some STAs that are not suitable to be taken as the neighbor STA may be excluded in these special cases with reference to the communication power of the STA and the AP, thereby improving efficiency of neighbor discovery.

In this case, the determining the neighbor STA based on power information of the another STA and the signal strength, and with reference to information of power at which the STA performs neighbor discovery to communicate with the AP specifically is: calculating a first difference value between the signal strength and power of the another STA; comparing the first difference value with a first preset threshold; calculating a second difference value between the power of the another STA and a power at which the STA needs to perform neighbor discovery to communicate with the AP; comparing the second difference value with a second preset threshold; and determining another corresponding STA as the neighbor STA when the first difference value is smaller than the first preset threshold and the second difference value is smaller than the second preset threshold.

Same as the first embodiment of the present invention, in the foregoing method for determining a neighbor station in a wireless local area network, when an STA is initially deployed in a coverage area of the AP, it firstly needs to perform an initial network entry process. Therefore, before receiving the message frame of the another STA and the AP, the STA that needs to perform neighbor discovery firstly communicates with the AP, so as to perform the initial network entry process, such as authentication and association, and the STA may indicate, to the AP through a message (such as an association request message) in the initial network entry process, that the STA supports an automatic neighbor discovery capability. In this case, the AP may obtain a list of STAs in the coverage area that are capable of performing automatic neighbor discovery, which is further convenient for managing the STAs in the coverage range.

In addition, same as the first embodiment of the present invention, in the foregoing method for determining a neighbor station in a wireless local area network, after discovering a neighbor STA, the STA may generate a neighbor list of the discovered neighbor STAs, and report the neighbor list to the AP. After receiving the neighbor list sent by the STA, the AP may further confirm the neighbor STAs included in the neighbor list according to the stored STA information, such as communication power and authentication information of each STA. For example, when the STA that needs to perform neighbor discovery accidentally receives a message frame from another STA in a different AP coverage range, and a ratio of signal strength of the message frame to initial transmit power meets the condition for neighbor discovery, the STA that needs to perform neighbor discovery also adds the STA to its neighbor list. However, because the STA does not belong to the same AP coverage range as the STA that needs to perform neighbor discovery, the STA that needs to perform neighbor discovery actually cannot relay data to be transmitted through the STA, and therefore, the STA is an invalid neighbor STA. And because the AP manages information of all STAs in the coverage range, the AP may exclude the invalid STA from the neighbor list of STAs, thereby improving validity of neighbor discovery. Or, for example, the AP deletes, according to the information of the objective and/or the cause of neighbor discovery of the STA, an STA with lower power than the STA performing neighbor discovery, thereby improving validity of neighbor discovery.

The second embodiment of the present invention further provides a station deployed in a wireless local area network, and the station includes: a first receiving unit, configured to receive a message frame on which another station communicates with an access point, where the message frame includes information of power used by the another station to send the message frame when communicating with the access point; a first determining unit, configured to determine signal strength of the received message frame; and a second determining unit, configured to determine a neighbor station based on the power information and the signal strength.

In the foregoing station, the first receiving unit is specifically configured to: wake up in time periods except a time period when the station communicates with the access point, and receive a message frame on which the another station communicates with the access point, where the another station communicates with the access point and transmits the message frame in a time period when the station wakes up.

In the foregoing station, the second determining unit includes: a calculating unit, configured to calculate a difference value between the signal strength and the power; a comparing unit, configured to compare the difference value with a first preset threshold; and a third determining unit, configured to: when the difference value is smaller than the preset threshold, determine another station as the neighbor station.

In the foregoing station, the second determining unit further includes: a third determining unit, configured to determine the neighbor station based on power information of the another station and the signal strength, and with reference to information of power at which a station needs to perform neighbor discovery to communicate with the access point.

In the foregoing station, the third determining unit specifically includes: a first calculating unit, configured to calculate a first difference value between the signal strength and power of the another station; a first comparing unit, configured to compare the first difference value with a first preset threshold; a second calculating unit, configured to calculate a second difference value between the power of the another station and power at which a station needs to perform neighbor discovery to communicate with the access point; a second comparing unit, configured to compare the second difference value with a second preset threshold; and a fourth determining unit, configured to: when the first difference value is smaller than the first preset threshold and the second difference value is smaller than the second preset threshold, determine another station as a neighbor station.

FIG. 5 is a schematic diagram showing an application of the method for determining a neighbor station according to the second embodiment of the present invention in a wireless local area network. As shown in FIG. 5, when needing to perform neighbor discovery, in S500, an STA that needs to perform neighbor discovery (marked as STAx in FIG. 5), sends an association request message to an AP, so as to indicate an automatic neighbor discovery capability to the AP. In S501, the STAx receives an association response message from the AP, thereby completing an initial network entry process. In S502, another STA communicates with the AP, so as to perform data transmission. In S503, the STAx communicates with the AP, so as to perform data transmission. In S504, the STAx wakes up in a time period except the time period when the STAx communicates with the AP, so as to receive a message frame on which the another STA communicates with the AP, discovers a neighbor STA based on the detected signal strength of the message frame and initial transmit power information included in the message frame, and generates a neighbor list. In S505, the STAx sends a neighbor report request message to the AP, where the neighbor report request message includes the neighbor list generated in the STAx. In S506, the AP confirms the neighbor list of the STAx based on the stored STA information, thereby, for example, excluding an STA not associated with the AP. In S507, the AP notifies the STAx of an available neighbor list through a neighbor report response message, and in this case, the STAx needing to perform neighbor discovery may automatically discover a neighbor STA for relaying data transmission.

In addition, the second embodiment of the present invention further provides a communication system including the station.

By using the method for determining a neighbor station in a wireless local area network, and the station, the access point, and the communication system that adopt the method according to the first embodiment and the second embodiment of the present invention, an STA may automatically discover a neighbor STA in a wireless local area network, thereby avoiding that human participation is needed for a process in which each STA configures neighbor information, and reducing work amount of deploying the wireless local area network. In addition, by using the method for determining a neighbor station in a wireless local area network according to the first embodiment and the second embodiment of the present invention, each STA may automatically discover the neighbor STA thereof, so that the maintenance of the wireless local area network is more convenient.

A person of ordinary skill in the art may be aware that, in combination with the examples described in the embodiments disclosed in this specification, units and algorithm steps may be implemented by electronic hardware, computer software, or a combination thereof. To clearly describe the interchangeability between the hardware and the software, the foregoing has generally described compositions and steps of each example according to functions. Whether the functions are performed by hardware or software depends on the particular applications and design constraint conditions of the technical solution. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and component or unit, reference may be made to a corresponding process in the foregoing method embodiments, and details are not described herein again.

In the several embodiments provided in the present application, it should be understood that the disclosed system, apparatus, and method may be implemented in other manners For example, the described apparatus embodiment is merely exemplary. For example, the component division is merely logical function division and may be other division in actual implementation. For example, a plurality of components or components may be combined or integrated into another system, or some features may be ignored or not performed. In addition, the displayed or discussed mutual couplings or direct couplings or communication connections may be implemented through some interfaces. The indirect couplings or communication connections between the apparatuses or components may be implemented in electronic, mechanical, or other forms.

The components described as separate parts may or may not be physically separate, and the parts displayed as components may or may not be physical components, may be located in one position, or may be distributed on a plurality of network components. Some or all of the units may be selected to achieve the objective of the solution of the embodiment according to actual needs.

In addition, functional units in the embodiments of the present invention may be integrated into one processing unit, or each of the units may exist alone physically, or two or more units may be integrated into one unit. The integrated units may be implemented in a form of hardware, or may be implemented in a form of a software functional unit.

When the integrated units are implemented in a form of a software functional unit and sold or used as an independent product, the integrated units may be stored in a computer-readable storage medium. Based on such an understanding, the technical solutions of the present invention essentially, or the part contributing to the prior art, or all or a part of the technical solutions may be implemented in a form of a software product. The computer software product is stored in a storage medium, and includes several instructions for instructing a computer device (which may be a personal computer, a server, or a network device) to perform all or a part of the steps of the methods described in the embodiment of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific embodiments of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the appended claims.

What is claimed is:

1. A method for determining a neighbor station in a wireless local area network, comprising:
sending, by a first station, a neighbor discovery request message to an access point;
receiving, by the first station, a neighbor discovery response message from the access point, wherein the neighbor discovery response message comprises information of one or more channel use time periods used for neighbor discovery, wherein the information is allocated by the access point to the first station;
broadcasting, by the first station, a neighbor discovery message at preset communication power in the one or more channel use time periods used for neighbor discovery;
receiving, by the first station, a neighbor response message responded to the neighbor discovery message by a second station, wherein the neighbor response message comprises station information of the second station; and
determining, by the first station, a neighbor station based on the station information of the second station.

2. The method according to claim 1, wherein before the sending, by a first station, a neighbor discovery request message to an access point, the method further comprises:
sending, by the first station, an association request message to the access point, wherein the association request message comprises information indicating that the first station supports an automatic neighbor discovery capability.

3. The method according to claim 1, wherein the neighbor discovery request message sent by the first station to the access point further comprises information of a cause and/or an objective for the first station to perform neighbor discovery.

4. The method according to claim 3, wherein the one or more channel use time periods correspond to wake-up time periods of all other stations in the wireless local area network, or wake-up time periods of a part of other stations selected by the access point based on the information of the cause and/or the objective for the first station to perform neighbor discovery.

5. The method according to claim 3, wherein the one or more channel use time periods are time periods except wake-up time periods of one or more other stations in the wireless local area network; and
the access point sends a neighbor discovery indication message to all the other stations in the wireless local area network, or to a part of other stations selected by the access point based on the information of the cause/the objective for the first station to perform neighbor discovery, wherein the neighbor discovery indication message comprises information of the one or more channel use time periods, so that all the other stations in the wireless local area network or the part of the other stations selected by the access point based on the information of the cause and/or the objective for the first station to perform neighbor discovery wake up in the one or more channel use time periods to receive the neighbor discovery indication message sent by the access point.

6. The method according to claim 5, wherein the neighbor discovery response message further comprises information of another channel frequency band for performing neighbor discovery, wherein the information is allocated by the access point to the first station, and the another channel frequency band is different from a channel frequency band for the first station to communicate with the access point; and
the broadcasting, by the first station, a neighbor discovery message at preset communication power in the one or more channel use time periods used for neighbor discovery specifically comprises:
broadcasting, by the first station, the neighbor discovery message by using the another channel frequency band at the preset communication power in the one or more channel use time periods used for neighbor discovery;
wherein the neighbor discovery indication message comprises information of the another channel frequency band, so that all the other stations in the wireless local area network or the part of the other stations selected by the access point based on the information of the cause and/or the objective for the first station to perform neighbor discovery receive, by using the another channel frequency band, the neighbor discovery indication message sent by the access point.

7. The method according to claim 6, wherein the information of the another channel frequency band for performing neighbor discovery comprises at least one of: a number of the another channel frequency band and a center frequency of the another channel frequency band.

8. The method according to claim 1, wherein the receiving, by the first station, a neighbor response message responded to the neighbor discovery message by another station specifically comprises:
receiving, by the first station, the neighbor response message responded to the neighbor discovery message by the another station in a time division multiplexing manner or a frequency division multiplexing manner.

9. The method according to claim 1, wherein after the receiving, by the first station, a neighbor response message responded to the neighbor discovery message by another station, wherein the neighbor response message comprises neighbor station information, so that the first station determines a neighbor station based on the neighbor station information, the method further comprises:
sending, by the first station, a neighbor report request message to the access point, wherein the neighbor report request message comprises the neighbor station information, so that the access point determines the neighbor station as a valid neighbor station according to stored status information of the neighbor station; and
receiving, by the first station, a neighbor report response message from the access point, wherein the neighbor report response message comprises information of the valid neighbor station.

10. A method for determining a neighbor station in a wireless local area network, comprising:
receiving, by an access point, a neighbor discovery request message sent by a first station;
allocating, by the access point, one or more channel use time periods used for neighbor discovery to the first station; and
sending, by the access point, a neighbor discovery response message to the first station, wherein the neighbor discovery response message comprises information of the one or more channel use time periods.

11. The method according to claim 10, wherein before the receiving, by an access point, a neighbor discovery request message from a first station, the method further comprises:
receiving, by the access point, an association request message from the first station, wherein the association request message comprises information indicating that the first station supports an automatic neighbor determining capability.

12. The method according to claim 10, wherein the neighbor discovery request message received by the access point from the first station further comprises information of a cause and/or an objective for the first station to perform neighbor discovery.

13. The method according to claim 12, wherein the one or more channel use time periods correspond to wake-up time periods of all other stations in the wireless local area network, or wake-up time periods of a part of other stations selected by the access point based on the information of the cause and/or the objective for the first station to perform neighbor discovery.

14. The method according to claim 12, wherein the one or more channel use time periods are time periods except wake-up time periods of one or more other stations in the wireless local area network; and
the allocating, by the access point, one or more channel use time periods used for neighbor discovery to the first station further comprises:
sending, by the access point, a neighbor discovery indication message to all the other stations in the wireless local area network, or to a part of other stations selected by the access point based on the information of the cause and/or the objective for the first station to perform neighbor discovery, wherein the neighbor discovery indication message comprises information of the one or more channel use time periods.

15. The method according to claim 14, wherein the neighbor discovery response message further comprises information of another channel frequency band for performing neighbor discovery, wherein the information is allocated by the access point to the first station, and the another channel frequency band is different from a channel frequency band for the first station to communicate with the access point.

16. The method according to claim 15, wherein the information of the another channel frequency band for performing neighbor discovery comprises at least one of: a number of the another channel frequency band and a center frequency of the another channel frequency band.

17. The method according to claim 10, wherein after the determining, by the first station, a neighbor station based on neighbor station information, the method further comprises:
receiving, by the access point, a neighbor report request message from the first station, wherein the neighbor report request message comprises the neighbor station information;
determining, by the access point, the neighbor station as a valid neighbor station according to stored status information corresponding to the neighbor station; and
sending, by the access point, a neighbor report response message to the station, wherein the neighbor report response message comprises information of the valid neighbor station.

18. A station deployed in a wireless local area network, comprising:
a first sending unit, configured to send a neighbor discovery request message to an access point;
a first receiving unit, configured to receive a neighbor discovery response message from the access point, wherein the neighbor discovery response message comprises information of one or more channel use time periods used for neighbor discovery, wherein the information is allocated by the access point to the station;
a broadcasting unit, configured to broadcast a neighbor discovery message at preset communication power in the one or more channel use time periods used for neighbor discovery;
a first receiving unit, configured to receive a neighbor response message responded to the neighbor discovery message by another station, wherein the neighbor response message comprises station information of the another station; and
a determining unit, configured to determine a neighbor station based on the station information of the another station.

19. The station according to claim 18, further comprising:
a second sending unit, configured to send an association request message to the access point, wherein the association request message comprises information indicating that the first station supports an automatic neighbor discovery capability.

20. The station according to claim 18, wherein the neighbor discovery request message sent to the access point further comprises information of a cause and/or an objective for the station to perform neighbor discovery.

21. The station according to claim 20, wherein the one or more channel use time periods correspond to wake-up time periods of all other stations in the wireless local area network, or wake-up time periods of a part of other stations selected by the access point based on the information of the cause and/or the objective for the station to perform neighbor discovery.

22. The station according to claim 20, wherein the one or more channel use time periods are time periods except wake-up time periods of one or more other stations in the wireless local area network; and
the access point sends a neighbor discovery indication message to all the other stations in the wireless local area network, or to a part of other stations selected by the access point based on the information the cause/the objective for the station to perform neighbor discovery, wherein the neighbor discovery indication message comprises information of the one or more channel use time periods, so that all the other stations in the wireless local area network or the part of the other stations selected by the access point based on the information of the cause and/or the objective for the station to perform neighbor discovery wake up in the one or more channel use time periods to receive the neighbor discovery indication message sent by the access point.

23. The station according to claim 22, wherein the neighbor discovery response message further comprises information of another channel frequency band for performing neighbor discovery, wherein the information is allocated by the access point to the station, and the another channel frequency band is different from a channel frequency band for the station to communicate with the access point; and
the broadcasting unit is specifically configured to:
broadcast a neighbor discovery message by using the another channel frequency band at the preset communication power in the one or more channel use time periods used for neighbor discovery;
wherein the neighbor discovery indication message comprises information of the another channel frequency band, so that all the other stations in the wireless local area network or the part of the other stations selected by the access point based on the information of the cause and/or the objective for the station to perform neighbor discovery receive, by using the another channel frequency band, the neighbor discovery indication message sent by the access point.

24. The station according to claim 23, wherein the information of the another channel frequency band for performing neighbor discovery comprises at least one of: a number of the another channel frequency band and a center frequency of the another channel frequency band.

25. The station according to claim 18, wherein the first receiving unit is specifically configured to:
receive the neighbor response message responded to the neighbor discovery message by the another station in a time division multiplexing manner or a frequency division multiplexing manner.

26. The station according to claim 18, further comprising:
a third sending unit, configured to send a neighbor report request message to the access point, wherein the neighbor report request message comprises neighbor station information, so that the access point determines the neighbor station as a valid neighbor station according to stored status information of the neighbor station; and
a second receiving unit, configured to receive the neighbor report response message from the access point, wherein the neighbor report response message comprises information of the valid neighbor station.

27. An access point deployed in a wireless local area network, comprising:
a first receiving unit, configured to receive a neighbor discovery request message sent by a station performing neighbor discovery;
an allocating unit, configured to allocate one or more channel use time periods used for neighbor discovery to a first station; and
a first sending unit, configured to send a neighbor discovery response message to the first station, wherein the neighbor discovery response message comprises information of the one or more channel use time periods.

28. The access point according to claim 27, further comprising:
a second receiving unit, configured to receive an association request message from the first station, wherein the association request message comprises information indicating that the first station supports an automatic neighbor determining capability.

29. The access point according to claim 27, wherein the neighbor discovery request message received from the first station further comprises information of a cause and/or an objective for the first station to perform neighbor discovery.

30. The access point according to claim 29, wherein the one or more channel use time periods correspond to wake-up time periods of all other stations in the wireless local area network, or wake-up time periods of a part of other stations selected by the access point based on the information of the cause and/or the objective for the first station to perform neighbor discovery.

31. The access point according to claim 29, wherein the one or more channel use time periods are time periods except wake-up time periods of one or more other stations except the first station in the wireless local area network; and
the allocating unit is further configured to:
send a neighbor determining indication message to all the other stations in the wireless local area network, or to a part of other stations selected by the access point based on the information of the cause and/or the objective for the first station to perform neighbor discovery, wherein the neighbor determining indication message comprises information of the one or more channel use time periods.

32. The access point according to claim 30, wherein the neighbor discovery response message further comprises information of another channel frequency band for performing neighbor discovery, wherein the information is allocated by the access point to the first station, and the another channel frequency band is different from a channel frequency band for the first station to communicate with the access point.

33. The access point according to claim 32, wherein the information of the another channel frequency band for performing neighbor discovery comprises at least one of: a number of the another channel frequency band and a center frequency of the another channel frequency band.

34. The access point according to claim 27, further comprising:
a third receiving unit, configured to receive a neighbor report request message from the first station, wherein the neighbor report request message comprises the neighbor station information;
a determining unit, configured to determine the neighbor station as a valid neighbor station according to stored status information corresponding to the neighbor station; and
a second sending unit, configured to send a neighbor report response message to the station, wherein the neighbor report response message comprises information of the valid neighbor station.

35. A method for determining a neighbor station in a wireless local area network, comprising:
receiving, by a first station, a message frame on which a second station communicates with an access point, wherein the message frame comprises information of power used by the second station to send the message frame when communicating with the access point;
determining signal strength of the received message frame; and
determining a neighbor station based on the power information and the signal strength.

36. The method according to claim 35, wherein the receiving, by a first station, a message frame on which a second station communicates with an access point specifically comprises:
waking up, by the first station, in time periods except a time period when the first station communicates with the access point, and receiving the message frame on which the second station communicates with the access point, wherein the second station communicates with the access point and transmits the message frame in a time period when the first station wakes up.

37. The method according to claim 35, wherein the determining a neighbor station based on the power information and the signal strength specifically comprises:
calculating a difference value between the signal strength and the power;
comparing the difference value with a first preset threshold; and
when the difference value is smaller than the preset threshold, determining the second station as the neighbor station.

38. The method according to claim 35, wherein the determining a neighbor station based on the power information and the signal strength further comprises:
determining the neighbor station based on power information of the another station and the signal strength, and with reference to information of power at which a station needs to perform neighbor discovery to communicate with the access point.

39. The method according to claim 38, wherein the determining the neighbor station based on power information of the another station and the signal strength, and with reference to information of power at which a station needs to perform neighbor discovery to communicate with the access point specifically comprises:
calculating a first difference value between the signal strength and power of the second station;
comparing the first difference value with a first preset threshold;
calculating a second difference value between the power of the second station and power at which the first station communicates with the access point;
comparing the second difference value with a second preset threshold; and
when the first difference value is smaller than the first preset threshold and the second difference value is smaller than the second preset threshold, determining the second station as the neighbor station.

40. A station deployed in a wireless local area network, comprising:
a first receiving unit, configured to receive a message frame on which another station communicates with an access point, wherein the message frame comprises information of power used by the another station to send the message frame when communicating with the access point;
a first determining unit, configured to determine signal strength of the received message frame; and
a second determining unit, configured to determine a neighbor station based on the power information and the signal strength.

41. The station according to claim 40, wherein the first receiving unit is specifically configured to:
wake up in time periods except a time period when the station communicates with the access point, and receive the message frame on which the another station communicates with the access point, wherein the another station communicates with the access point and transmits the message frame in a time period when the station wakes up.

42. The station according to claim 40, wherein the second determining unit comprises:
a calculating unit, configured to calculate a difference value between the signal strength and the power;
a comparing unit, configured to compare the difference value with a first preset threshold; and
a third determining unit, configured to: when the difference value is smaller than the preset threshold, determine another station as the neighbor station.

43. The station according to claim 40, wherein the second determining unit further comprises:
a third determining unit, configured to determine the neighbor station based on power information of the another station and the signal strength, and with reference to information of power at which a station needs to perform neighbor discovery to communicate with the access point.

44. The station according to claim 43, wherein the third determining unit specifically comprises:
a first calculating unit, configured to calculate a first difference value between the signal strength and power of the another station;
a first comparing unit, configured to compare the first difference value with a first preset threshold;
a second calculating unit, configured to calculate a second difference value between the power of the another station and power at which a station needs to perform neighbor discovery to communicate with the access point;
a second comparing unit, configured to compare the second difference value with a second preset threshold; and
a fourth determining unit, configured to: when the first difference value is smaller than the first preset threshold and the second difference value is smaller than the second preset threshold, determine another station as the neighbor station.
